(19) United States
(12) Patent Application Publication
(10) Pub. No.: US 2013/0198369 A1
(43) Pub. Date: Aug. 1, 2013

(54) METHOD AND APPARATUS FOR MAPPING LOCATOR AND IDENTIFIER OF MOBILE HOST

(71) Applicants: Jung-Im KIM, Daejeon (KR); Tae-Wan YOU, Daejeon (KR); Hee-Young JUNG, Daejeon (KR); Jung-Ha HONG, Daejeon (KR)

(72) Inventors: Jung-Im KIM, Daejeon (KR); Tae-Wan YOU, Daejeon (KR); Hee-Young JUNG, Daejeon (KR); Jung-Ha HONG, Daejeon (KR)

(73) Assignee: Electronics and Telecommunications Research Institute, Daejeon (KR)

(21) Appl. No.: 13/535,972

(22) Filed: Jun. 28, 2012

(30) Foreign Application Priority Data
Jan. 30, 2012 (KR) 10-2012-0009202

(51) Int. Cl. G06F 15/173

(52) U.S. Cl. 709/224

(57) ABSTRACT

Disclosed are a method and an apparatus for mapping a locator and an identifier of a host by using an administrative domain identifier.

A method that allows an administration domain to map location information of an internal host located in the administration domain with an identifier of the internal host, includes: receiving an internal host location information registration message from the internal host, by an access router that the internal host accesses; receiving the location information registration message from the access router, by a registration server of the administrative domain; and extracting a locator of the access router from the location information registration message and mapping the locator with the internal host identifier, by the registration server.

### CROSS-REFERENCE TO RELATED APPLICATIONS

The present application claims priority of Korean Patent Application No. 10-2012-0009202, filed on Jan. 30, 2012, which is incorporated herein by reference in its entirety.

### BACKGROUND OF THE INVENTION

1. Field of the Invention

Exemplary embodiments of the present invention relates to a method and an apparatus for mapping a locator and an identifier of a mobile host, and more particularly, to a method and an apparatus for mapping a locator and an identifier of a mobile host, using an administrative domain identifier.

2. Description of Related Art

One IP (Internet Protocol) includes location information and identifier information of a mobile host and the internet performs routing by using the IP. Presently, IETF (Internet Engineering Task Force) that is an internet standard organization has introduced LISP (Locator Identifier Separation Protocol) type as a type for solving problems in extension, security, and mobility due to a rapid increase in scale of the network. The LISP type performs routing with a locator at a core network and performs routing with an identifier at an edge network, on a network composed of the core and the edge.

When the host moves in the LISP type, it is necessary to update the mapping of the locator and the identifier to change only the locator without changing the identifier of the host.

### SUMMARY OF THE INVENTION

An embodiment of the present invention is directed to solve problems in extension and security of the internet by mapping the locator and the identifier of a host, using an administrative domain identifier.

Further, an embodiment of the present invention is directed to decrease the amount of transmitted messages and increase the transmission speed, by updating the mapping information of a locator and an identifier, using a plurality of administrative domains configuring a network.

The foregoing and other objects, features, aspects and advantages of the present invention will be understood and become more apparent from the following detailed description of the present invention. Also, it can be easily understood that the objects and advantages of the present invention can be realized by the units and combinations thereof recited in the claims.

A method that allows an administration domain to map location information of an internal host located in the administration domain with an identifier of the internal host, includes: receiving an internal host location information registration message from the internal host, by an access router that the internal host accesses; receiving the location information registration message from the access router, by a registration server of the administrative domain; and extracting a locator of the access router from the location information registration message and mapping the locator with the internal host identifier, by the registration server.

An apparatus configured to map the location information of the internal host positioned in the administrative domain with the identifier of the internal host, includes: a message receiving unit configured to receive a location information registration message of the internal host transmitted from the internal host; an extracting unit configured to extract the locator of an access router, which the internal host accesses, from the location information registration message; and a mapping unit configured to map the locator of the access router with the identifier of the internal host.

A method that allows a first administrative domain to map location information of an external host located in a second administrative domain after joining the first administrative domain with an identifier of the external host, includes: receiving an external host location information registration message from the external host, by a registration server of the second administrative domain; receiving the location information registration message from the registration server of the second administrative domain, by a registration server of the first administrative domain; and extracting an identifier of the second administration domain from the location information registration message and mapping the extracted identifier with the external host identifier, by the registration server of the first administrative domain.

An apparatus configured to map location information of an external host, which is located in a second administrative domain after joining a first administrative domain, with an identifier of the external host, includes: a message receiving unit configured to receive an external host location information registration message transmitted from a registration server of the second administration domain; an extracting unit configured to extract the second administrative domain identifier from the location information registration message; and a mapping unit configured to map the second administration domain identifier with the external host identifier.

According to the present invention described above, it is possible to solve the problems in extension and security of the internet by mapping a locator and an identifier of a host by using an administrative domain identifier.

Further, according to the present invention, it is possible to decrease the amount of transmitted messages and increase the transmission speed, by updating the mapping information of a locator and an identifier, using a plurality of administrative domains configuring a network.

### BRIEF DESCRIPTION OF THE DRAWINGS

FIG. 1 is a diagram illustrating a packet transmission according to an LISP type.

FIG. 2 is a diagram illustrating the configuration of an apparatus for mapping a locator and an identifier of a host in accordance with an embodiment of the present invention.

FIG. 3 is a diagram illustrating a connection type of administrative domains in accordance with an embodiment of the present invention.

FIG. 4 is a diagram illustrating registration of a locator and an identifier in accordance with an embodiment of the present invention.

FIG. 5 is a diagram illustrating a host location information request and a response according to an embodiment of the present invention.

FIG. 6 is a diagram illustrating a method of mapping location information of an internal host located in an administrative domain with a locator and an identifier of the internal host in accordance with an embodiment of the present invention.

FIG. 7 is a diagram illustrating a method of mapping location information of an external host located in a foreign administrative domain with an identifier of the external host, after joining a home administrative domain, in accordance with an embodiment of the present invention.

FIG. 8 is a diagram illustrating a data packet and a control packet in accordance with an embodiment of the present invention.

FIG. 9 is a flowchart illustrating a method of mapping a locator and an identifier of a host in accordance with an embodiment of the present invention.

FIG. 10 is a flowchart illustrating a method of mapping a locator and an identifier of a host in accordance with another embodiment of the present invention.

### DESCRIPTION OF SPECIFIC EMBODIMENTS

The above-mentioned objects, features, and advantages will be described in detail with reference to the accompanying drawings. Therefore, exemplary embodiments will be described in detail with reference to the accompanying drawings so that they can be easily practiced by those skilled in the art to which the present invention pertains. Further, when it is determined that the detailed description of the known art related to the present invention may obscure the gist of the present invention, the detailed description thereof will be omitted. Hereinafter, preferred embodiments of the present invention will be described in detail with reference to the accompanying drawings. In the drawings, like reference numerals denote like or similar functions in various aspects.

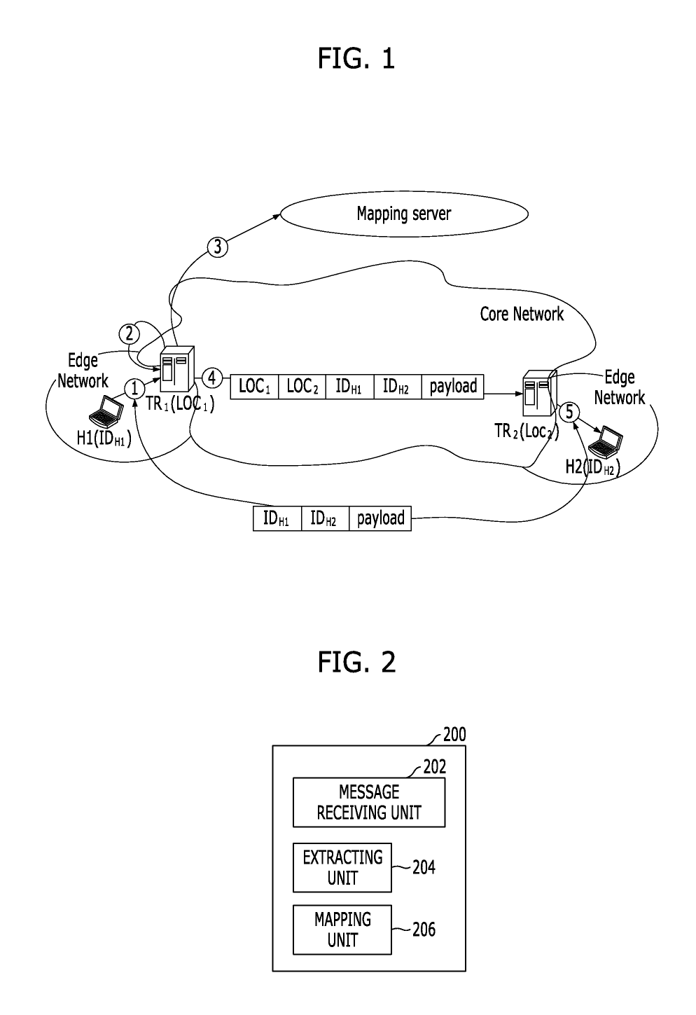

FIG. 1 is a diagram illustrating a packet transmission according to an LISP type.

Referring to FIG. 1, an LISP type uses a tunneling technique through mapping and encapsulation as a type of dividing a locator and an identifier. In the LISP type, an identifier may be assigned to a host to identify an endpoint host on the worldwide network, and a locator may be assigned to a router to locate the host by recognizing the router that the host accesses, on a core network.

A first host H1 may transmit a packet that requests location information of a second host H2 to a first tunnel router 1 (TR1) (\textcircled{1}). Further, the first tunnel router TR1 may search mapping information of a locator and an identifier of the second host H2 from a registration server of the first tunnel router TR1 itself (\textcircled{2}). When the location information of the second host H2 is not searched from the registration server of the first tunnel router TR1, the first tunnel router TR1 may transmit a packet for requesting the location information of the second host to a mapping server storing the mapping information of the locator and the identifier of the host (\textcircled{3}). The first tunnel router TR1 receiving the location information of the second host from the mapping server transmits a packet where the locator LOC2 of the second tunnel router TR2, which the second host H2 accesses, is encapsulated, to a core network. The packet is routed by using router locators LOC1 and LOC2 on the core network (\textcircled{4}) and routed by using identifiers ID_{H1}, ID_{H2} on an edge network (\textcircled{5}).

The LISP type transmits a control message in the cases of \textcircled{1}, \textcircled{2}, and \textcircled{3} which request location information, and a data message in the case of \textcircled{4} and \textcircled{5} As in the related art, when the control message and the data message are routed by using the IP addresses, for the characteristics of the IP address supposing the host connected and fixed to a specific edge network, there is a defect that rebooting should be performed to update the IP address every time the host moves to a different edge network or the like, the table of the locator and the identifier should be changed to allow another host to recognize the location information of the moved host, and the data service that is being provided now is stopped. In order to complement the defect, the LISP type uses a mobile IP including a home address that is assigned from the home network and permanently used and a care-of address that can be changed when the network moves. However, when the mobile IP address is used, there is a defect that unnecessary routing is performed because all of data are transmitted necessarily through the home network of each host regardless of the locations of the transmitting/receiving hosts.

Further, when an IP is used for routing of the control message and the data message is performed, there is a limit in protection of the location information of the host.

FIG. 2 is a diagram illustrating the configuration of an apparatus for mapping a locator and an identifier of a host in accordance with an embodiment of the present invention.

Referring to FIG. 2, an apparatus 200 for mapping a locator and an identifier of a host may be configured to include a message receiving unit 202, an extracting unit 204, and a mapping unit 206.

According to an embodiment of the present invention, it is possible to ensure extension by dividing and operating the entire network into a plurality of administrative domains, as the scale of the network increases. One host may be joint one administrative domain and the administrative domain may assign a host identifier to the joined host. The host may move in one administrative domain or move from one administrative domain to another administrative domain, and it is necessary map the location information of the host with the identifier of the host in order to find the location of the host when the host moves. It may be possible to register the location information of the host on the administrative domain when the host moves, in order to map the identifier and the locator of the host. Information transmitted from a transmitting host to a receiving host may include a control message and a data message, in which the data message may be routed by using the locator on a core network and may be routed by using the identifier on the edge network.

The apparatus 200 for mapping a locator and an identifier of a host may discriminate location information of an internal host located in the administrative domain and an external host not located in the administrative domain, and may map the location information with the identifier of the host.

The apparatus 200 for mapping the location information of the internal host located in the administrative domain with the identifier of the internal host may be configured to include a message receiving unit 202 configured to receive a location information registration message of the internal host transmitted from the internal host, an extracting unit 204 configured to extract the locator of an access router, which the internal host accesses, from the location information registration message, and a mapping unit 206 configured to map the locator of the access router with the identifier of the internal host.

Further, the apparatus 200 for mapping the location information of the external host joining the first administrative domain and located in the second administrative domain is an apparatus included in a first administrative domain registration server and may be configured to include a message receiving unit 202 configured to receive the location information registration message of the external host transmitted from the registration server of the second administrative domain, an extracting unit 204 configured to extract the identifier of the second administrative domain from the location information registration message, and a mapping unit 206 configured to map the identifier of the second administrative domain with the identifier of the external host.

The internal host identifier and the external host identifier may include the identifiers of the administrative domains that the internal host and the external host join.

Further, the internal host identifier and the external host identifier may include an output value obtained by inputting a public key into a hash function. As described above, since the identifiers do not include the location information of the host, security may be improved.

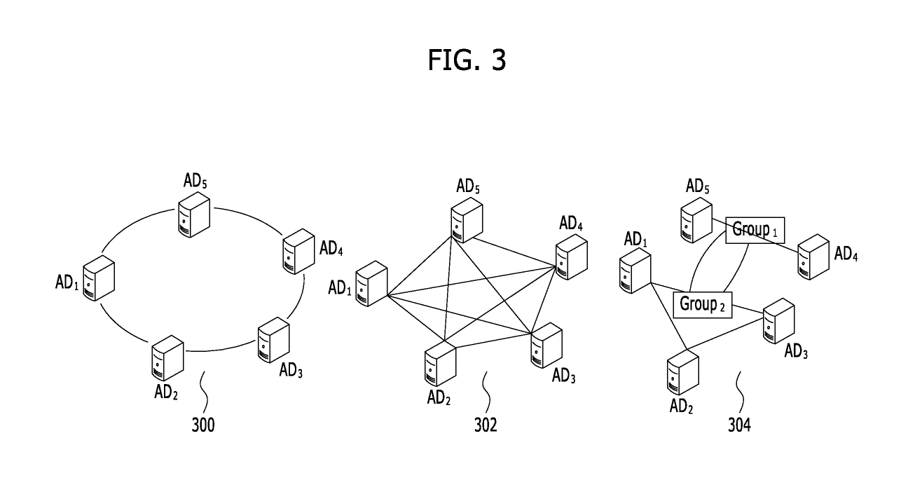

FIG. 3 is a diagram illustrating a connection type of administrative domains in accordance with an embodiment of the present invention.

Referring to FIG. 3, the connection type of administrative domains may be configured to include a distribution type 300, a mesh type 302, and a hybrid type 304.

Since all of administrative domains AD1 to AD5 are not connected in the distribution type 300, it is economical and it is difficult to know the information on the administrative domains when the administrative domain identifiers do not have a specific structure, thereby enhancing security. All the administrative domains AD1 to AD5 are connected with each other in the mesh type 302, thus messages are transmitted fast. Therefore, when administrative domain identifiers do not have a specific structure or the number of administrative domains is large in order to enhance security, the administrative domains are connected by the distribution type 300, and when the number of administrative domains is small, the mesh type 302 may be used. Further, the hybrid type 304 in which some (AD 1 to AD3, AD4 and AD5) of the administrative domains are connected in the mesh type and groups Group1 and Group 2 are connected in the distribution type may be used. As described above, as the network is divided into a plurality of administrative domains and the administrative domains map the host identifiers with the location information of the hosts, messages can be normally routed even if the network is extended. Further, even if one administrative breaks, it is possible to use the information on mapping the host identifier and the host location information in each of the administrative domain, and accordingly, it is possible to locate the host that receives a message.

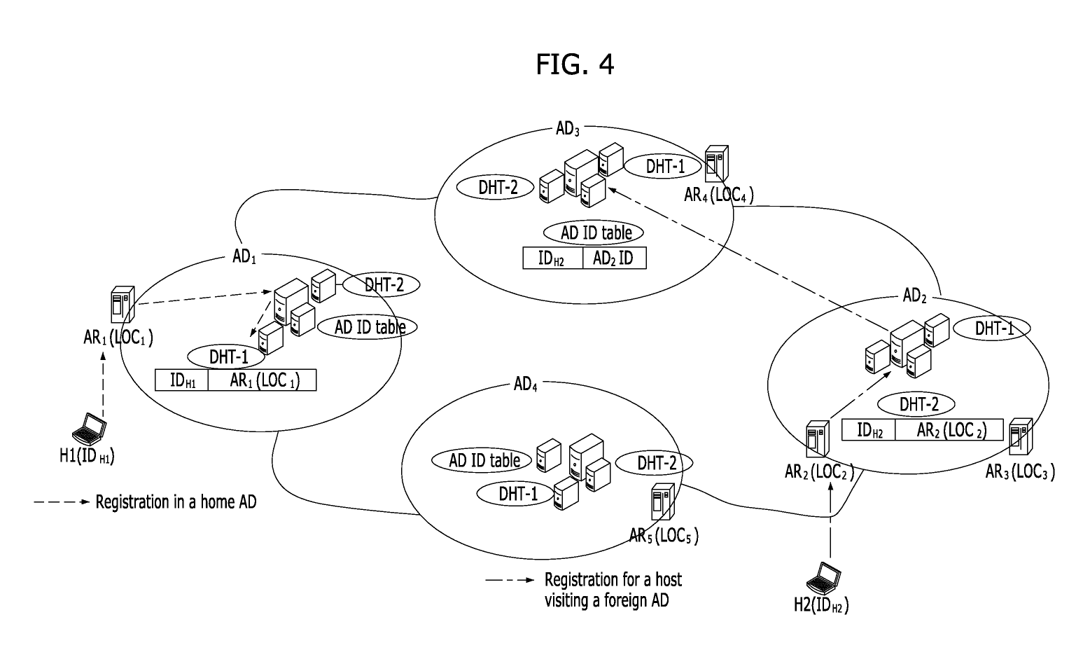

FIG. 4 is a diagram illustrating registration of a locator and an identifier in accordance with an embodiment of the present invention.

Referring to FIG. 4, the first to fourth administrative domains AD1 to AD4 may support extension of the network by registering and mapping the locators and the identifiers of the hosts, respectively. The administrative domains that the hosts join are called home administrative domains and the administrative domains that the hosts are visiting without joining are called foreign administrative domains. The home administrative domains may assign a host identifier including a home administrative domain identifier to the joined hosts. Therefore, when the hosts are located in the foreign administrative domains, the hosts can register the information on the home administrative domains of the hosts by registering the host identifiers on the registration servers of the foreign administrative domains. When the hosts are located in the foreign administrative domains, a response for a message requesting the location of the host may be the information on not the router to which the hosts are connected, but the administrative domains where the hosts are located.

Each of the administrative domains may include a registration server (registration point) where the identifiers and the locations of the hosts are registered. The administrative domain can map the identifiers and the locators of the hosts registered on the registration server in three kinds of mapping tables in accordance with the locations of the hosts. The administrative domain may register the identifiers and the locators of the hosts located in the administrative domain on first and second mapping tables DHT-1 and DHT-2 and may register the identifier and the locator of the host not located in the administrative domain on a third mapping table AD ID table. For the convenience, three mapping tables are illustrated as three mapping servers, respectively.

The administrative domain may register the identifier and the locator located in the administrative domain on the first mapping table DHT-1. The location information of the host joining the administrative domain in the hosts located in the administrative domain may be registered on the first mapping table DHT-1. For example, the first administrative domain AD1 may register the location information of the first host H1 joining the first administrative domain AD1 and located in the first administrative domain AD1, on the first mapping table DHT-1 of the first administrative domain AD1. A first access router AR1 where the first host accesses may receive a first host H1 registration message transmitted from the first host H1. Subsequently, the first access router AR1 may transmit the first host location information registration message to the registration server of the first administrative domain AD1. The first administrative domain registration server may extract the locator LOC1 of the first access router AR1 and the first host identifier ID_{H1} from the first host location information registration message. The first administrative domain registration server may map the first host identifier ID_{H1} with the first access router locator LOC1 and register the mapping result on the first mapping table DHT-1. Since the identifier registered in the first mapping table DHT-1 is not limited to a specific structure, the mapping table may be used in a distribution type, such as CAN(Content Addressable Network) or CHORD.

Further, the administrative domain may register the identifier and the locator located in the administrative domain on the second mapping table DHT-2. The location information of the host not joining the administrative domain in the hosts located in the administrative domain may be registered on the second mapping table DHT-2. Further, the administrative domain may register the identifier and the locator not located in the administrative domain on the third mapping table AD ID table. The location information of the host joining the administrative domain in the hosts not located in the administrative domain may be registered on the third mapping table AD ID table. For example, when the home administrative domain of the second host H2 is the third administrative domain AD3 and the foreign administrative domain is the second domain AD2, the third administrative domain AD3 may register the location information of the second host H2 in the third mapping table AD ID table and the second administrative domain AD2 may register the location information of the second host H2 in the second mapping table DHT-2. First, the second access router AR2 may receive a location information registration message transmitted from the second host H2. Subsequently, the second access router AR2 may transmit the second host location information registration message to the registration server of the second administrative domain AD2. The second administrative domain registration server may extract the locator LOC1 of the second access router AR2 and the second host identifier ID_{H2} from the second host location information registration message. The second administrative domain registration server may map the second host identifier ID_{H2} with the second access router locator LOC2 and register the mapping result on the second mapping table DHT-2. Thereafter, the second administrative domain registration server may transmit a second host location information registration message to the registration server of the third administrative domain AD3 that is the home administrative domain of the second host H2. The third administrative domain AD3 may extract a second administrative domain identifier AD2 ID from the second host location information registration message. The third administrative domain registration server may map the second host identifier ID_{H2} with the second administrative domain identifier AD2 ID and register the mapping result on the third mapping table AD ID table.

When the second host H2 moves in the second administrative domain AD2 that is the foreign administrative domain after the location information is registered first, the registration server of the second administrative domain AD2 may update the mapping information by registering the second host identifier ID_{H2} and an access router locator, which the second host H2 newly access, in the second mapping table DHT-2 while the second administrative domain registration server does not separately transmit the second host location information registration message to the registration server of the third administrative domain AD3 that is the home administrative domain of the second host H2.

When the second host H2 moves to a fourth administrative domain AD4 after the location information is registered first, a fourth administrative domain registration server may transmit a new second host location information registration message to the registration server of the third administrative domain AD3 that is the home administrative domain of the second host H2. Subsequently, the third administrative domain registration server may update the mapping information by registering the second host identifier ID_{H2} and a fourth administrative domain identifier AD4 ID in the third mapping table AD ID table. The fourth administrative domain registration server may transmit the movement information of the second host H2 to the second administrative domain registration server that is the previous foreign administrative domain. The second administrative domain registration server that has received the information that the second host has moved to another administrative domain may delete the location information of the second host H2 from the second mapping table DHT-2, after a predetermined time has passed.

As described above, as the administrative domains update the mapping tables, respectively, and use the distribution type for the mapping tables, it is possible to solve the problem in extension on the network. Since the administrative domains use the administrative domain identifiers, when receiving a request for the location information of the hosts, it is possible to more quickly a response for the request for the location information. It is possible to surely know the destination to transmit a host location information request message and the time taken to search the location information of the hosts in the administrative domain registration server reduces, by using the administrative domain identifier. Further, since the administrative domains register and update the location information of the host in three kinds of mapping tables in accordance with the location of the host and whether the host joins the administrative domains, and transmit the location change information of the host only to the administrative domain that the host joins and the administrative domain where the host is located, the amount of information to be transmitted is reduced.

The first host identifier ID_{H1} and the second host identifier ID_{H2} may include the hash values of an administrative domain identifier and a public key. The first and second host identifiers ID_{H1} and ID_{H2} may be assigned from the home administrative domain. As the host identifier includes the administrative domain identifier, it is possible to search the location of the host in the administrative domain after searching first the administrative domain when searching the location of the host, thus it is possible to decrease the search range. As the search range decreases, it is possible to decrease the transmission range of the location information registration message or the location information request message. Since the administrative domain identifier is a value that is uniquely provided on the network, it may have a value different from another administrative domain identifier. Further, the public key hash value is a value that is uniquely provided throughout the world, which is a value output by inputting a public key into a hash function. If the same value is output even though public keys with different values are input to a hash function, only one public key of the two public keys may be used.

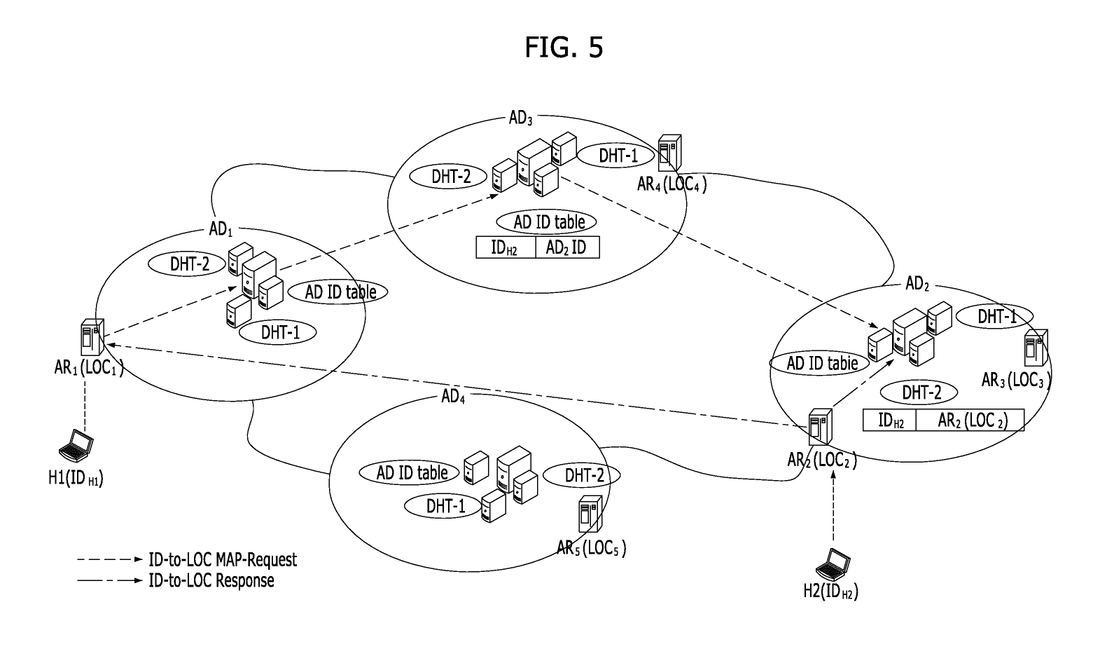

FIG. 5 is a diagram illustrating a host location information request and a response according to an embodiment of the present invention.

Referring to FIG. 5, the first host H1 accesses the first access router AR1 in the first administrative domain AD1 and needs to know the access location of the second host H2 to communicate with the second host H2. The first host H1 may transmit a second host location information request message to the first access router AR1. The first access router AR1 may transmit the second host location information request message to the third administrative domain AD3 that is the home administrative domain of the second host H2. When the second administrative domain identifier AD2 ID mapped with the second host identifier ID_{H2} is searched from the third mapping table AD ID table as the result that the third administrative domain registration server searches the mapping tables, it may be possible to transmit the second host location information request message to the second administrative domain registration server. When the locator LOC2 of the second access router AR2 mapped with the second host identifier ID_{H2} is searched from the second mapping table DHT-2 as the result that the second administrative domain registration server receiving the second host location information request message searches the mapping tables, the second administrative domain registration server may transmit the second host location information request message to the second access router AR2. The second access router AR2 may directly transmit a reply message for the second host location information request to the first access router AR1 that the first host H1 accesses. As the second access router AR2 directly transmits the second host location information reply message to the first access router AR1 not through the administrative domains, a response work may be performed faster. The second host location information request and replay messages are control messages and routed by using the administrative domain identifier included in the host identifier. Control messages can be quickly processed when routing that uses the administrative domain identifier is performed, than when routing that uses an IP is performed.

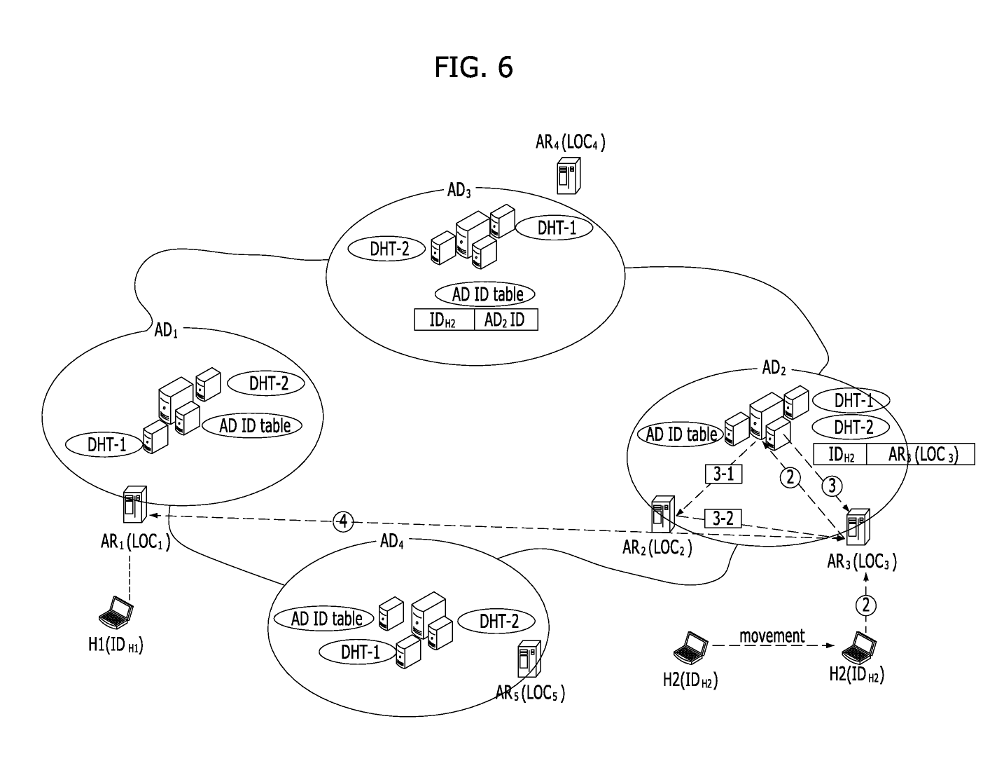

FIG. 6 is a diagram illustrating a method of mapping location information of an internal host located in an administrative domain with an identifier of the internal host in accordance with an embodiment of the present invention.

Referring to FIG. 6, when the access router that the second host H2 accesses is changed to a third access router AR3 from the second access router AR2 after the response for the location information request described with reference to FIG. 5 is performed, that is, when the second host H2 moves in the same foreign administrative domain, it is possible to update the location information of the second host H2 in two methods. However, the method of updating the location information is not limited to the two methods.

According to the first method, when the second host H2 transmits a second host location information change message to the third access router AR3 (\textcircled{1}), the third access router AR3 may transmit the second host location information change message to the second administrative domain registration server (\textcircled{2}). The second administrative domain can update the location information of the second host by mapping and registering the second host identifier ID_{H2} with a locator LOC3 of the third access router on the second mapping table DHT-2. Subsequently, the second administrative domain registration server may transmit a message including the information of confirming that the second host location information change message has been received, to the third access router AR3 (\textcircled{3}). Thereafter, the third access router AR3 may transmit a message including the second host location change information to the first access router AR1 (\textcircled{4}). Thereafter, the first access router AR1 may determine routing such that a data message is transmitted to the third router AR3 that the second host H2 accesses.

According to the second method, when the second host H2 transmits a second host location information change message to the third access router AR3 (\textcircled{1}), the third access router AR3 may transmit the second host location information change message to the second administrative domain registration server (\textcircled{2}). The second administrative domain registration server may transmit the second host location information change message to the second access router AR2 that the second host H2 has accessed before moving (3-1) and the second access router AR2 may transmit a message including the information of confirming that the second host location information change message has been received, to the third access router AR3 that accesses after the second host H2 moves (3-2). Thereafter, the third access router AR3 may transmit a message including the second host location change information to the first access router AR1 (\textcircled{4}).

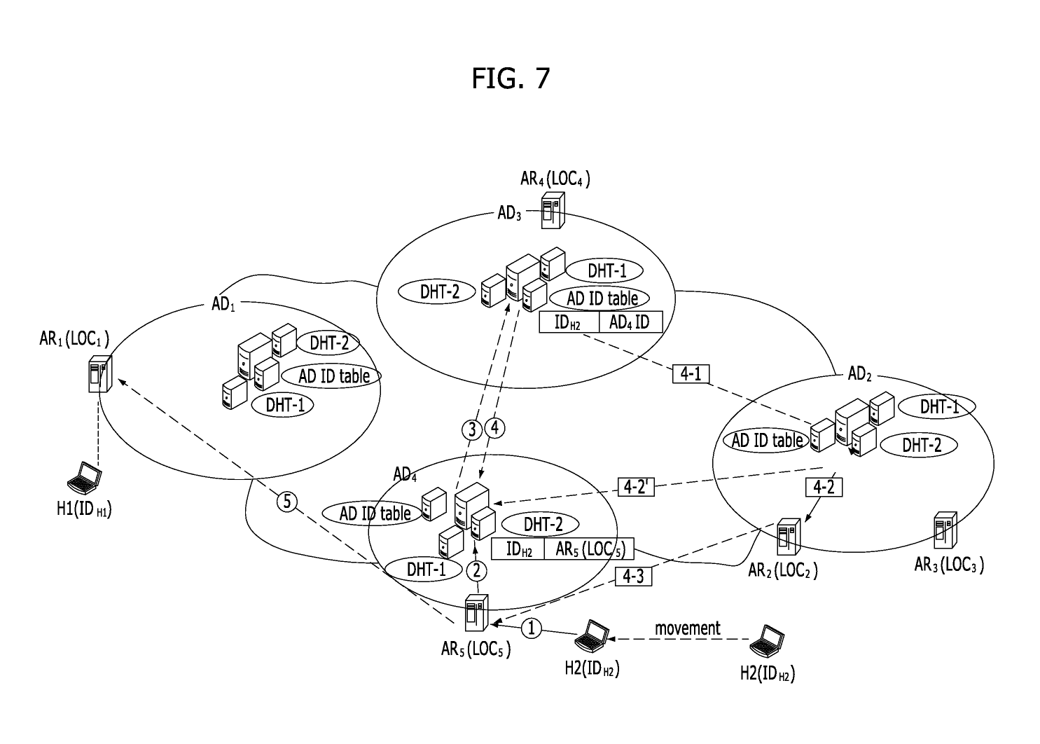

FIG. 7 is a diagram illustrating a method of mapping location information of an external host positioned in a foreign administrative domain with an identifier of the external host, after joining a home administrative domain, in accordance with an embodiment of the present invention.

Referring to FIG. 7, when the access router that the second host H2 accesses is changed to a fifth access router AR5 from the second access router AR2 after the response for the location information request described with reference to FIG. 5 is performed, that is, when the second host H2 moves from the second administrative domain AD2 to the fourth administrative domain AD4, it is possible to update the location information of the second host H2 in two methods. However, the method of updating the location information is not limited to the two methods.

According to the first method, when the second host H2 transmits a second host location information change message to the fifth access router AR5 (\textcircled{1}), the fifth access router AR5 may transmit the second host location information change message to the fourth administrative domain registration server (\textcircled{2}) When the fourth administrative domain registration server transmits the second host location change information message to the registration server of the third administrative domain AD3 that is the home administrative domain of the second host H2 (\textcircled{3}), the third administrative domain registration server can update the location information of the second host by mapping and registering the second host identifier ID_{H2} with a fourth administrative domain identifier AD4 ID on the third mapping table AD ID. Subsequently, the third administrative domain registration server may transmit a message including the information of confirming that the second host location information change message has been received, to the fourth administrative domain registration server (\textcircled{4}). Thereafter, the fifth access router AR5 may transmit a message including the second host location change information to the first access router AR1 (\textcircled{5}). Thereafter, the first access router AR1 may determine routing such that a data message is transmitted to the fifth router AR5 that the second host H2 accesses.

According to the second method, when the second host H2 transmits a second host location information change message to the fifth access router AR5 (\textcircled{1}), the fifth access router AR5 may transmit the second host location information change message to the fourth administrative domain registration server (\textcircled{2}). When the fourth administrative domain registration server transmits a second host location information change message to the third administrative domain registration server (\textcircled{3}), the third administrative domain registration server may transmit a message saying that the location of the second host has changed, to the registration server of the second administrative domain AD2 that has been located before the second host H2 moves. The third administrative domain registration server may request the second administrative domain registration server to delete the second host location information from the second mapping table DHT-2 of the second administrative domain AD2 after a predetermined has passed. The second administrative domain registration server may transmit the second host location information change message to the second access router AR2 that the second host H2 has accessed before moving (4-2) and the second access router AR2 may transmit a message including the information of confirming that the second host location information change message has been received, to the fifth access router AR5 (4-3). Further, the second administrative domain registration server may confirm that the control channel normally operates, by transmitting the information received for the second host H2 to the fourth administrative domain registration server (4-2′). Thereafter, the fifth access router AR5 may transmit a message including the second host location change information to the first access router AR1 (\textcircled{5}). Thereafter, the first access router AR1 may determine routing such that a data message is transmitted to the fifth router AR5 that the second host H2 accesses.

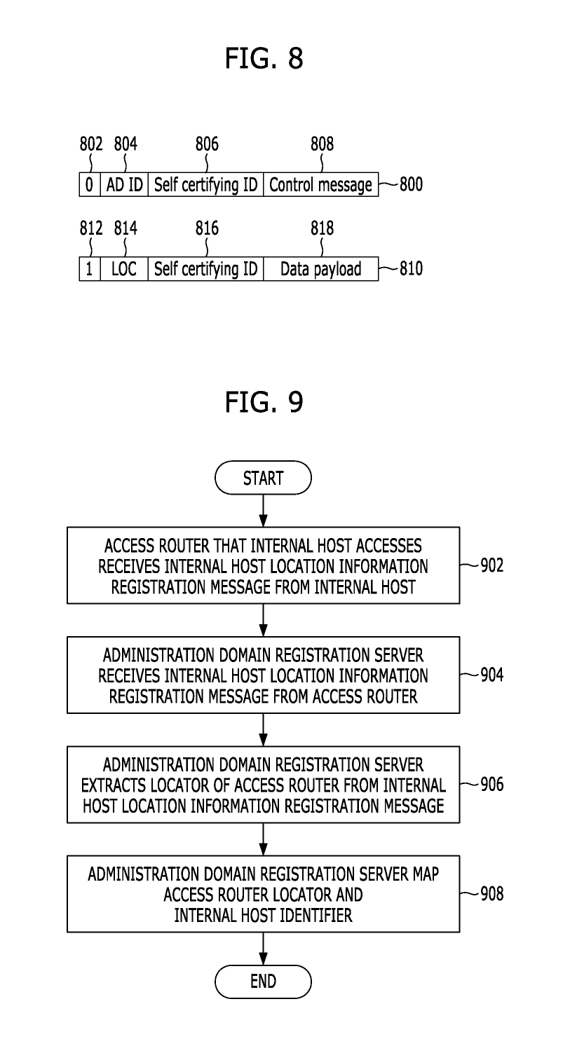

FIG. 8 is a diagram illustrating a data packet and a control packet in accordance with an embodiment of the present invention.

Referring to FIG. 8, according to an embodiment of the present invention, a control packet 800 and a data packet 810 may be divided and transmitted to process a control message faster. For example, a host moves, the host location on a network is reported to an administrative domain registration server that maps a locator and an identifier, the host is located by transmitting a control message first, and then a data message may be transmitted.

The first one bit of the packet header may be set different to discriminate the control packet 800 and the data packet 810. For example, the first one bit of the packet header of the control message may be set as 0 (802) and the first one bit of the packet header of the data message may be set as 1 (812).

A message is generally divided into a header and a payload, in which the header includes information for routing and the payload includes a message to be transmitted. In order to discriminate the control packet 800 from the data packet 810, the header of the control packet 800 may include an administrative domain identifier 804 and a self-certifying identifier 806 and the header of the data packet 800 may include an access router locator 814 and a self-certifying identifier 816. The control packet 800 may perform routing to the administrative domain where the host is located, by using the administrative domain identifier 804. On the contrary, the data packet 810 may perform routing to the access router that the host accesses, by using the access router locator 814.

When the administrative domain identifier 804 that the control packet 800 uses includes a home administrative domain identifier, not only the registration server of the foreign administrative domain, but the registration server of the home administrative domain may receive the location information registration message of the host.

The self-certifying identifiers 806 and 816 use self-certifying names as the identifiers. The self-certifying name is configured by cryptography that makes it possible to check whether the name itself matches with the current transmitted information. For example, the self-certifying identifiers 806 and 816 may be configured by output values obtained by inputting a public key into a hash function. The self-certifying identifiers 806 and 816 does not include the location information of a host, does not have a structure, and performs certification on a packet, thus system security on the network may be enhanced. It is necessary to install a router supporting a self-certifying name in overlay on the internet network in order to be able to the self-certifying name as an identifier.

FIG. 9 is a flowchart illustrating a method of mapping a locator and an identifier of a host in accordance with an embodiment of the present invention.

Referring to FIG. 9, in order for an administrative domain to map the location information of an internal host located in the administrative domain with the identifier of the internal host, an access router that the internal host accesses may receive an internal host location information registration message from the internal host (902).

Subsequently, the registration server of the administrative domain may receive the internal host location information registration message from the access router (904).

The administrative domain registration server may extract the locator of the access router and the internal host identifier from the location information registration message (906).

The administrative domain registration server may map the extracted router locator and internal host identifier (908).

The internal host identifier may include an output value obtained by inputting a public key into a hash function.

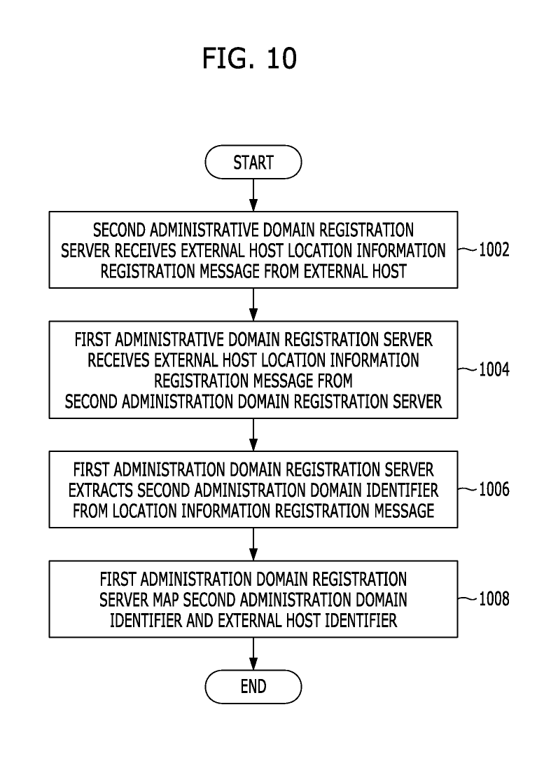

FIG. 10 is a flowchart illustrating a method of mapping a locator and an identifier of a host in accordance with another embodiment of the present invention.

Referring to FIG. 10, as a method that the first administrative domain maps the location information of an external host, which is located in the second administrative domain after joining the first administrative domain, with the identifier of the external host, the registration server of the second administrative domain may receive an external host location information registration message from the external host (1002).

Subsequently, the registration server of the first administrative domain may receive the external host location information registration message from the registration server of the second administrative domain (1004).

The registration server of the first administrative domain may extract the identifier of the second administrative domain and the external host identifier from the external host location information registration message (1006).

The first administrative domain registration server may map the extracted second administrative domain identifier and external host identifier (1008).

The external host identifier may include an output value obtained by inputting a public key into a hash function.

While the present invention has been described with respect to the specific embodiments, it will be apparent to those skilled in the art that various changes and modifications may be made without departing from the spirit and scope of the invention. Accordingly, the scope of the invention is not limited to exemplary embodiments as described above and is defined by the following claims and equivalents to the scope the claims.

What is claimed is:

1. A method that allows an administration domain to map location information of an internal host located in the administration domain with an identifier of the internal host, the method comprising:
receiving an internal host location information registration message from the internal host, by an access router that the internal host accesses;
receiving the location information registration message from the access router, by a registration server of the administrative domain; and
extracting a locator of the access router from the location information registration message and mapping the locator with the internal host identifier, by the registration server.

2. The method of claim 1, wherein the internal host identifier includes an identifier of an administrative domain that the internal host joins.

3. The method of claim 1, wherein the internal host identifier may include an output value obtained by inputting a public key into a hash function.

4. A method that allows a first administrative domain to map location information of an external host located in a second administrative domain after joining the first administrative domain with an identifier of the external host, the method comprising:
receiving an external host location information registration message from the external host, by a registration server of the second administrative domain;
receiving the location information registration message from the registration server of the second administrative domain, by a registration server of the first administrative domain; and
extracting an identifier of the second administration domain from the location information registration message and mapping the extracted identifier with the external host identifier, by the registration server of the first administrative domain.

5. The method of claim 4, wherein the external host identifier includes an identifier of an administrative domain that the external host joins.

6. The method of claim 4, wherein the external host identifier may include an output value obtained by inputting a public key into a hash function.

7. An apparatus configured to map the location information of the internal host positioned in the administrative domain with the identifier of the internal host, the apparatus comprising:
a message receiving unit configured to receive a location information registration message of the internal host transmitted from the internal host;
an extracting unit configured to extract the locator of a access router, which the internal host accesses, from the location information registration message; and
a mapping unit configured to map the locator of the access router with the identifier of the internal host.

8. The apparatus of claim 7, wherein the internal host identifier includes an identifier of an administrative domain that the internal host joins.

9. The apparatus of claim 7, wherein the internal host identifier may include an output value obtained by inputting a public key into a hash function.

10. An apparatus configured to map location information of an external host, which is located in a second administrative domain after joining a first administrative domain, with an identifier of the external host, the apparatus comprising:
a message receiving unit configured to receive an external host location information registration message transmitted from a registration server of the second administration domain;
an extracting unit configured to extract the second administrative domain identifier from the location information registration message; and
a mapping unit configured to map the second administration domain identifier with the external host identifier.

11. The apparatus of claim 10, wherein the external host identifier includes an identifier of an administrative domain that the external host joins.

12. The apparatus of claim 10, wherein the internal host identifier may include an output value obtained by inputting a public key into a hash function.
